(19) United States
(12) Patent Application Publication
(10) Pub. No.: US 2007/0103396 A1
(43) Pub. Date: May 10, 2007

(54) Method for driving discharge display panel to lower rated voltage of driving apparatus and driving apparatus having lower rated voltage

(76) Inventor: Sung-Su Lee, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/593,491

(22) Filed: Nov. 7, 2006

(30) Foreign Application Priority Data
Nov. 8, 2005 (KR) 10-2005-0106393

(51) Int. Cl. G09G 3/28

(52) U.S. Cl. 345/63

(57) ABSTRACT

A method of driving a discharge display panel, including X electrode lines, Y electrode lines and address electrode lines, to display at least one frame of an image, wherein the frame includes a plurality of subfields, and during a reset period of at least one of the plurality of subfields, the method may include increasing a potential of the Y electrode lines to a first potential with positive polarity, maintaining the Y electrode lines at the first potential for a setting time, dropping the potential of the Y electrode lines from the first potential to a ground potential, maintaining the Y electrode lines at the ground potential for a predetermined period of time, and dropping the potential of the Y electrode lines from the ground potential to a second potential with negative polarity.

### BACKGROUND OF THE INVENTION

1. Field of the Invention

The invention relates to a method of driving a discharge display panel and a driving apparatus having a lower rated voltage. More particularly, the invention relates to a method of driving a discharge display panel that includes, e.g., X electrode lines, Y electrode lines, and address electrode lines, and a driving apparatus capable of performing such a method.

2. Description of the Related Art

A conventional discharge display apparatus, e.g., a plasma display apparatus, may display gray levels of an image(s) by dividing a unit frame period into a plurality of subfields. Each of the subfields may include a reset period, an addressing period, and a sustain period. Each of the subfields may have a unique gradation weight, and the sustain period for each subfield may be set in proportion to the respective gradation weight.

In such a conventional discharge display apparatus, a potential(s) of the Y electrode lines, which are often called scan electrode lines, may rise to a highest potential during the reset period. Thereafter, the potential of the Y electrode lines may fall to a lower potential before falling to a lowest potential. In this case, the highest potential may not affect a rated voltage of a driving apparatus because two potentials may be combined by a capacitor. However, the rated voltage of the driving apparatus may still correspond to the potential of the highest-potential power supply employed by the discharge display apparatus.

More particularly, an upper limit of a reset voltage pulse is generally higher than, e.g., an upper limit of a sustain voltage pulse. Although a difference between the upper limit of the sustain voltage pulse and the upper limit of the reset voltage pulse may result from charge stored in a capacitor, generally, a rated voltage of the driving circuit may correspond, e.g., to a potential of the upper limit of the sustain voltage pulse.

### SUMMARY OF THE INVENTION

The invention is therefore directed to a method of driving a discharge display panel and a driving apparatus, which substantially overcome ones or more of the problems due to limitations and disadvantages of the related art.

It is therefore a feature of an embodiment of the invention to provide a method of driving a discharge display panel to lower a rated voltage of a driving apparatus.

At least one of the above and other features of advantages of the invention may be realized by providing

A method of driving a discharge display panel, including X electrode lines, Y electrode lines and address electrode lines, to display at least one frame of an image, wherein the frame includes a plurality of subfields, and during a reset period of at least one of the plurality of subfields, the method includes increasing a potential of the Y electrode lines to a first potential with positive polarity, maintaining the Y electrode lines at the first potential for a setting time, dropping the potential of the Y electrode lines from the first potential to a ground potential, maintaining the Y electrode lines at the ground potential for a predetermined period of time, and gradually dropping the potential of the Y electrode lines from the ground potential to a second potential with negative polarity.

Increasing the potential of the Y electrode lines to the first potential may include gradually increasing the potential of the Y electrode lines from a third potential with positive polarity to the first potential with positive polarity. Increasing the potential of the Y electrode lines to the first potential may include substantially instantaneously increasing the potential of the Y electrode lines from the ground potential to the third potential and maintaining the Y electrodes lines at the third potential for a predetermined period of time. Increasing the potential of the Y electrode lines to the first potential involves gradually increasing the potential of the Y electrode lines from the third potential to the first potential.

The method may include applying the ground potential to the X electrode lines while increasing the potential of the Y electrode lines from the third potential with positive polarity to the first potential with positive polarity, and while maintaining the Y electrode lines at the first potential during the setting time. The method may include applying a fifth potential with positive polarity lower than the first potential with positive polarity to the X electrode lines, while dropping the potential of the Y electrode lines from the first potential to the second potential.

The address electrode lines may be maintained at the ground potential during the reset period. The method may include applying a pulse of the second potential with negative polarity to respective ones of the Y electrode lines to be selected, and applying a fourth potential with negative polarity higher than that second potential with negative polarity to unselected ones of the Y electrode lines. The discharge display panel may be a plasma display panel.

At least one of the above and other features of advantages of the invention may be separately realized by providing a method of driving a discharge display panel including X electrode lines, Y electrode lines, and address electrode lines by using a driving apparatus of a discharge display apparatus, the method including dividing a unit frame into a plurality of subfields for a time-sharing gray-scale display, and dividing each of the subfields into a reset period, an addressing period, and a sustain period, wherein the reset period of at least one of the subfields may include a potential rising period during which a potential applied to the Y electrode lines gradually rises to a first potential with positive polarity; a high-potential maintaining period during which the potential applied to the Y electrode lines is maintained at the first potential with positive polarity for a setting time, a stabilizing period during which the potential applied to the Y electrode lines is maintained at a ground potential, and a potential falling period during which the potential applied to the Y electrode lines gradually falls from the ground potential to a second potential with negative polarity.

The driving apparatus may include an X driver driving the X electrode lines, an Y driver driving the Y electrode lines, and an address driver driving the address electrode lines, wherein the Y driver may include a reset/sustain circuit generating potentials to be applied to the Y electrode lines during the reset and sustain periods, a scan driving circuit generating potentials to be applied to the Y electrode lines during the addressing period; and a switching output circuit applying the potentials from the reset/sustain circuit and the potentials from the scan driving circuit to the Y electrode lines, wherein the switching output circuit may include upper transistors and lower transistors respectively corresponding to the Y electrode lines, and the method may include applying potentials to the Y electrode lines through the upper transistors of the switching output circuit during the potential rising period, the high-potential maintaining period, and the stabilizing period.

During the potential falling period, the method may include applying potentials to the Y electrode lines through the lower transistors of the switching output circuit. The potential applied to the Y electrode lines may gradually rise from a third potential with positive polarity to the first potential with positive polarity. During the addressing period, a pulse of the second potential with negative polarity may be applied to some of the Y electrode lines to be scanned, and a fourth potential with negative polarity higher than the second potential with negative polarity may be applied to the remaining Y electrode lines. The third potential with positive polarity may be generated by a difference between the second potential with negative polarity and the fourth potential with negative polarity during the potential rising period.

The ground potential may be applied to the X electrode lines during the potential rising period. A fifth potential with positive polarity lower than the first potential with positive polarity may be applied to the X electrode lines. The discharge display panel may be a plasma display panel.

At least one of the above and other features of advantages of the invention may be separately realized by providing a driving apparatus for driving a discharge panel including X electrode lines, Y electrode lines and address electrode lines, the driving apparatus including a processor for dividing a unit frame into a plurality of subfields for a time-sharing gray scale display, and dividing each of the subfields into a reset period, an addressing period, and a sustain period, and a Y driver for driving the Y electrode lines, the Y driver including a reset/sustain circuit for generating potentials to be applied to the Y electrodes lines during the reset and sustain periods, the reset/sustain circuit including potential increasing device for increasing a potential of the Y electrode lines to a first potential with positive polarity, high-potential maintaining device for maintaining the potential of the Y electrode lines at the first potential for a setting time, stabilizing device for stabilizing the Y electrode lines by applying a ground potential to the Y electrode lines, and potential dropping device for allowing the potential applied to the Y electrode lines to gradually fall from the ground potential to a second potential with negative polarity.

The driving apparatus may include a scan driving circuit for generating potentials to be applied to the Y electrode lines during the addressing period; and a switching output circuit for applying the potentials from the reset/sustain circuit with potentials from the scan driving circuit to the Y electrode lines, wherein the switching output circuit may include upper transistors and lower transistors respectively corresponding to the Y electrode lines, and the potential increasing device, the high-potential maintaining device and the stabilizing device may use the upper transistors of the switching circuit to control the potentials applied to the Y electrode lines.

### BRIEF DESCRIPTION OF THE DRAWINGS

The above and other features and advantages of the invention will become more apparent to those of ordinary skill in the art by describing in detail exemplary embodiments thereof with reference to the attached drawings in which:

FIG. 1 illustrates an internal perspective view of a plasma display panel with a three-electrode surface discharge structure, as an exemplary discharge display device;

FIG. 2 illustrates a schematic cross-sectional view of one display cell in the exemplary plasma display panel illustrated in FIG. 1;

FIG. 3 illustrates a timing diagram of driving signals that may be applied to Y electrode lines of the plasma display panel illustrated in FIG. 1 using an address-display separation driving method according to an exemplary embodiment of the invention;

FIG. 4 illustrates a block diagram of a driving apparatus employable for driving the plasma display panel illustrated in FIG. 1;

FIG. 5 illustrates an exemplary timing diagram of driving signals that may be employed to drive the plasma display panel illustrated in FIG. 1 during a single exemplary subfield of the driving method employing one or more aspects of the invention;

FIG. 6 illustrates a distribution of wall charges at time t5 of the timing diagram illustrated in FIG. 5;

FIG. 7 illustrates a distribution of wall charges at time t8 of the timing diagram illustrated in FIG. 5;

FIG. 8 illustrates an exemplary scan driving circuit and an exemplary switching output circuit that may be employed in the Y driver of the driving apparatus illustrated in FIG. 4;

FIG. 9 illustrates an exemplary reset/sustain circuit illustrated in FIG. 8;

FIG. 10 illustrates exemplary control signals that may be supplied, during a reset period, to transistors illustrated in FIGS. 8 and 9; and

FIG. 11 illustrates an exemplary circuit diagram of the X driver included in the driving apparatus illustrated in FIG. 4.

### DETAILED DESCRIPTION OF THE INVENTION

Korean Patent Application No. 10-2005-0106393, filed on Nov. 8, 2005, in the Korean Intellectual Property Office, and entitled: “Method of Driving Discharge Display Panel to Lower Rated Voltage of Driving Apparatus,” is incorporated by reference herein in its entirety.

The invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

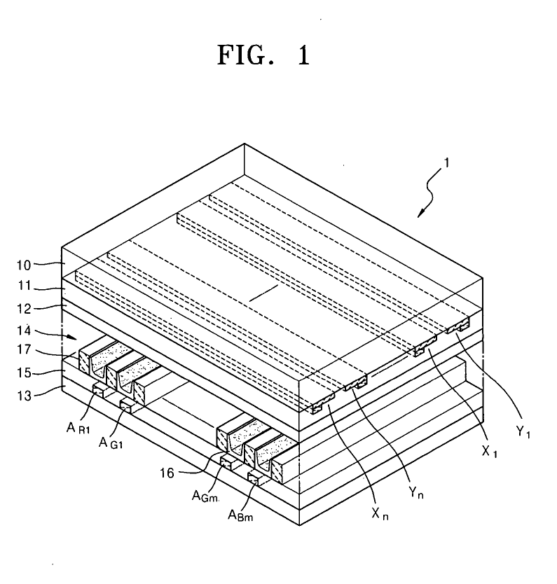

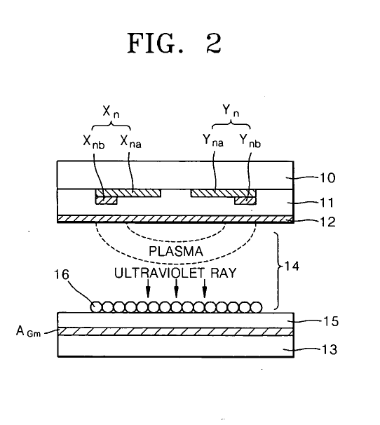

FIG. 1 illustrates an internal perspective view of a plasma display panel 1 including a three-electrode surface discharge structure, as an exemplary display device that may employ a driving method employing one or more aspects of the invention. FIG. 2 illustrates a schematic cross-sectional view of one display cell in the plasma display panel 1 illustrated FIG. 1.

Referring to FIGS. 1 and 2, the plasma display panel may include address electrode lines A_{R1}, . . . , A_{Bm}, upper and lower dielectric layers 11 and 15, Y-electrode lines Y₁, . . . , Yₙ, X-electrode lines X₁, . . . , Xₙ, phosphors 16, barrier ribs 17, and a protective layer 12, e.g., MgO layer, between front and rear glass substrates 10 and 13.

The address electrode lines A_{R1}, . . . , A_{Bm} may be formed in a predetermined pattern on an upper surface of the rear glass substrate 13. The lower dielectric layer 15 may cover the address electrode lines A_{R1}, . . . , A_{Bm}. The barrier ribs 17 may extend on an upper surface of the lower dielectric layer 15. The barrier ribs 17 may extend along a direction that is substantially parallel to a direction along which the address electrode lines A_{R1}, . . . A_{Bm}. The barrier ribs 17 may partition discharge areas associated with, e.g., respective display cells, and may prevent cross-talk between the display cells. The phosphors 16 may be provided, e.g., between adjacent ones of the barrier ribs 17.

The X-electrode lines X₁, . . . , Xₙ and Y electrode lines Y₁, . . . , Yₙ may be formed in a predetermined pattern on a lower surface of the front glass substrate 10. The X-electrode lines X₁, . . . , Xₙ and the Y-electrode lines Y₁, . . . , Yₙ may extend along a direction orthogonal to the direction along which the address electrode lines A_{R1}, . . . , A_{Bm} extend. Each intersection may define a corresponding display cell. Each of the X-electrode lines X₁, . . . , Xₙ and each of the Y-electrode lines Y₁, . . . , Yₙ may be formed by coupling transparent electrode lines, e.g., Xₙₐ and Yₙₐ illustrated in FIG. 2, which may include a transparent conductive material, e.g., ITO (Indium Tin Oxide), with metal electrode lines, e.g., X_{nb} and Y_{nb} illustrated in FIG. 2. The metal electrode lines may help enhance conductivity of the X-electrode lines X₁, . . . , Xₙ and each of the Y-electrode lines Y₁, . . . , Yₙ. The upper dielectric layer 11 may cover the X-electrode lines X₁, . . . , Xₙ and Y electrode lines Y₁, . . . , Yₙ. The protective layer 12 may help protect the plasma display panel 1 from a strong electric field. The protective layer 12 may be, e.g., an MgO layer, and may be formed on a lower surface of the front electronic layer 11. A discharge space 14 may be filled with plasma-forming gas and may be sealed.

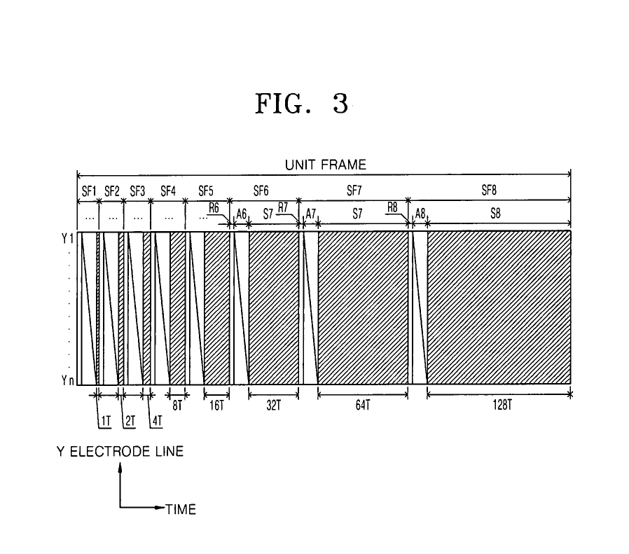

FIG. 3 illustrates a timing diagram of driving signals that may be applied to Y electrode lines Y₁, . . . , Yₙ of the plasma display panel 1 illustrated in FIG. 1 using an address-display separation driving method according to an exemplary embodiment of the invention. Referring to FIG. 3, each unit frame may be partitioned into a plurality of subfields, e.g., 8 subfields SF1, . . . , SF8, in order to implement time-sharing gray-scale display. The subfields SF1, SF8 may be divided into reset periods R1, . . . , R8, addressing periods A1, . . . , A8, and sustain periods S1, . . . , S8, respectively.

Discharge conditions of all the display cells may be completely and/or substantially completely equalized during the respective reset periods R1, . . . , R8.

During each of the addressing periods A1, . . . , A8, the display data signal may be sequentially applied to the address electrode lines, e.g., A_{R1} A_{Bm} of FIG. 1, while injection pulses corresponding to each of the Y electrode lines Y₁, . . . , Yₙ may be sequentially applied to the address electrode lines A_{R1}, . . . A_{Bm}. Accordingly, if a display data signal with a high level is applied while the injection pulses are applied, wall charges may be generated by address discharge in a corresponding discharge cell, and no wall charge may be generated in the remaining discharge cells.

During each of the sustain periods S1, . . . , S8, sustain pulses may be alternately applied to all the Y electrode lines Y₁, . . . , Yₙ and all the X electrode lines X₁, . . . , Xₙ, so that the discharge cells in which the wall charges were formed during the previous respective addressing period A1, . . . , A8 may undergo display discharge. Accordingly, luminance of the plasma display panel may be proportional to a length of a sustain period S1, . . . , S8 occupied by a unit frame. The length of the sustain period S1, . . . , S8 occupied by a unit frame may be 255T, where T is a unit of time. Accordingly, the length of the sustain period S1, . . . , S8 may be represented by 256 gradations, including a no-display case in which nothing may be displayed, during the unit frame.

Referring to FIG. 3, a sustain period S1 of a first subfield SF1 may be set to a time 1T corresponding to 2⁰, a sustain period S2 of a second subfield SF2 may be set to a time 2T corresponding to 2¹, a sustain period S3 of a third subfield SF3 may be set to a time 4T corresponding to 2², a sustain period S4 of a fourth subfield SF4 may be set to a time 8T corresponding to 2³, a sustain period S5 of a fifth subfield SF5 may be set to a time 16T corresponding to 2⁴, a sustain period S6 of a sixth subfield SF6 may be set to a time 32T corresponding to 2⁵, a sustain period S7 of a seventh subfield SF7 may be set to a time 64T corresponding to 2⁶, and a sustain period S8 of an eighth subfield SF8 may be set to a time 128T corresponding to 2⁷, respectively.

Accordingly, by appropriately selecting respective ones of the respective subfields, e.g., eight subfields, to be displayed, a display with corresponding gradation, e.g., 256 gradations may be implemented. The gradations may include a zero (0) gradation, which may correspond to nothing being displayed, e.g., solid black.

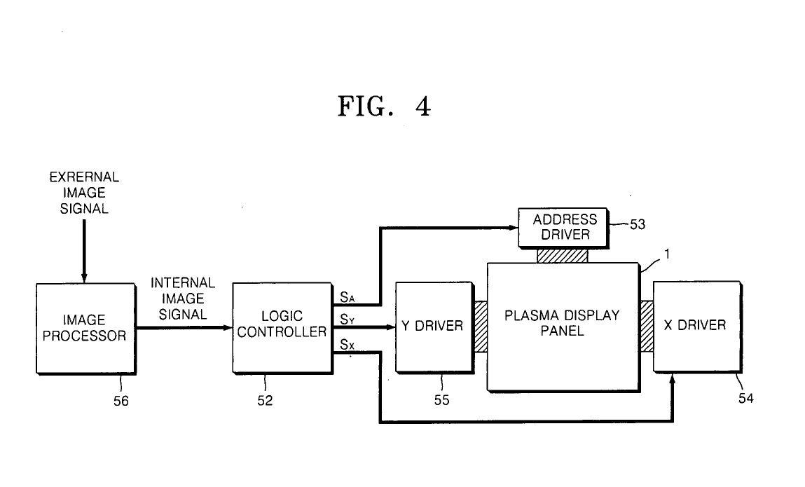

FIG. 4 illustrates a block diagram of a driving apparatus employable for driving the plasma display panel illustrated in FIG. 1. Referring to FIG. 4, the driving apparatus may include an image processor 56, a logic controller 52, an address driver 53, an X driver 54, and a Y driver 55. The image processor 56 may convert external analog image signals into digital signals to generate clock signals, vertical and horizontal synchronization signals, and internal image signals, e.g., red (R), green (G), and blue (B) image data each including, e.g., 8 bits. The logic controller 52 may generate driving control signals S_{A}, S_{Y}, and S_{X} according to the internal image signals that may be output from the image processor 56. The address driver 53 may process an address signal S_{A} among the driving control signals S_{A}, S_{Y}, and S_{X} output from the logic controller 52, generate a display data signal, and transmit the display data signal to the address electrode lines (A_{R1}, . . . , A_{Bm} of FIG. 1). The X driver 54 may process an X driving control signal S_{X} among the driving control signals S_{A}, S_{Y}, and S_{X} output from the controller 52 and drive the X electrode lines (X₁, . . . , Xₙ of FIG. 1). The Y driver 55 may process a Y driving control signal S_{Y} among the driving control signals S_{A}, S_{Y}, and S_{X} output from the logic controller 52 and drive the Y electrode lines (Y₁, . . . , Yₙ of FIG. 1).

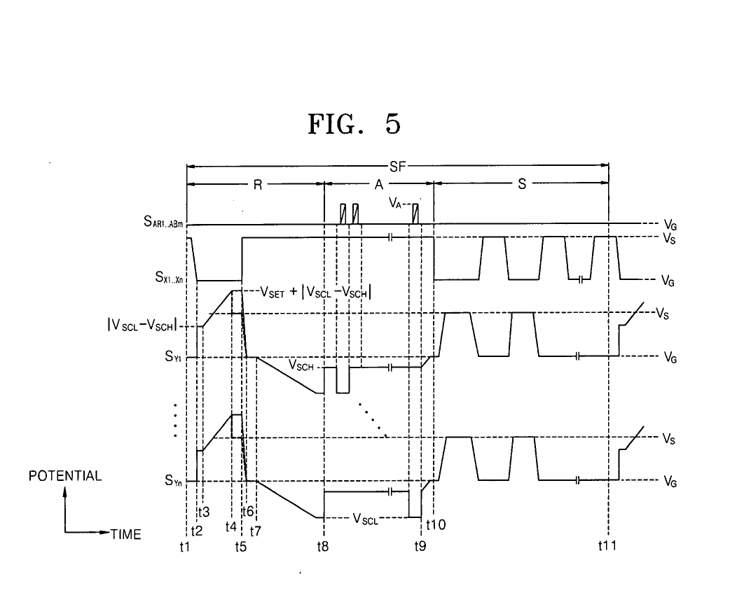

FIG. 5 illustrates an exemplary timing diagram of driving signals that may be employed to drive the plasma display panel illustrated in FIG. 1 during a single exemplary subfield SF of the driving method employing one or more aspects of the invention. In FIG. 5, reference numeral S_{AR1 . . . ABm} corresponds to a driving signal that may be applied to each of the address electrode lines (A_{R1}, A_{G1}, . . . , A_{Gm}, A_{Bm} of FIG. 1), reference numeral S_{X1 . . . . Xn} corresponds to a driving signal that may be applied to each of the X electrode lines (X₁, . . . , Xₙ of FIG. 1), and reference numeral S_{Y1}, . . . , S_{Yn} corresponds to a driving signal that may be applied to each of the Y electrode lines (Y₁, . . . , Yₙ of FIG. 1).

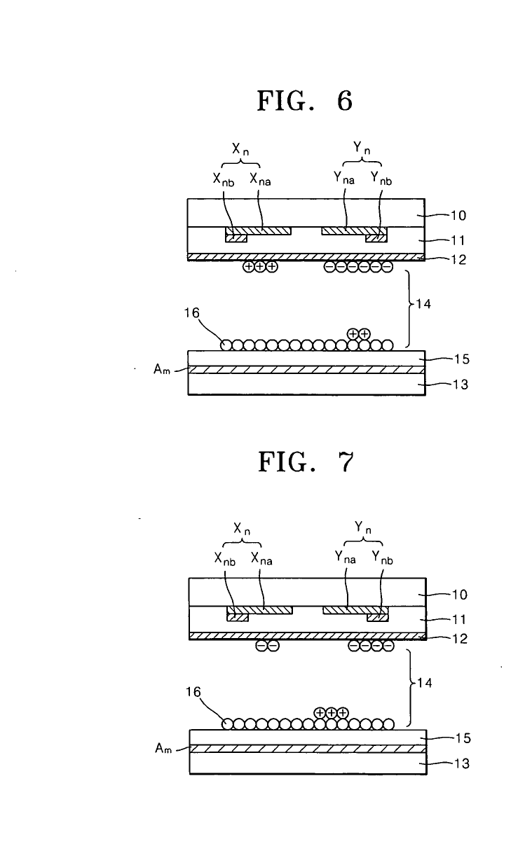

FIG. 6 illustrates a distribution of wall charges at time t5 of the timing diagram illustrated in FIG. 5, i.e., after a gradually increasing potential is applied to all the Y electrode lines Y₁, . . . , Yₙ during the reset period R. FIG. 7 illustrates a distribution of wall charges at time t8 of the timing diagram illustrated in FIG. 5, i.e., after the reset period R is terminated. In FIGS. 6 and 7, components having the same reference numerals as those of FIG. 2 operate in the same manner as the respective components of FIG. 2.

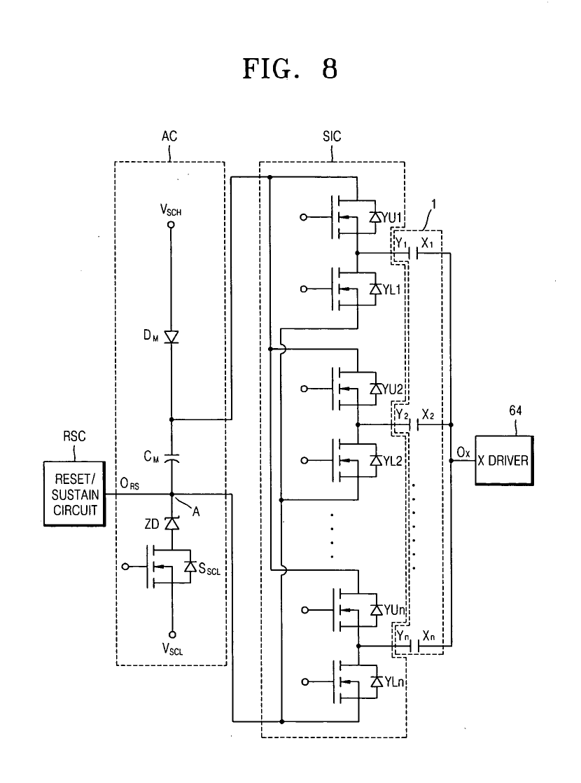

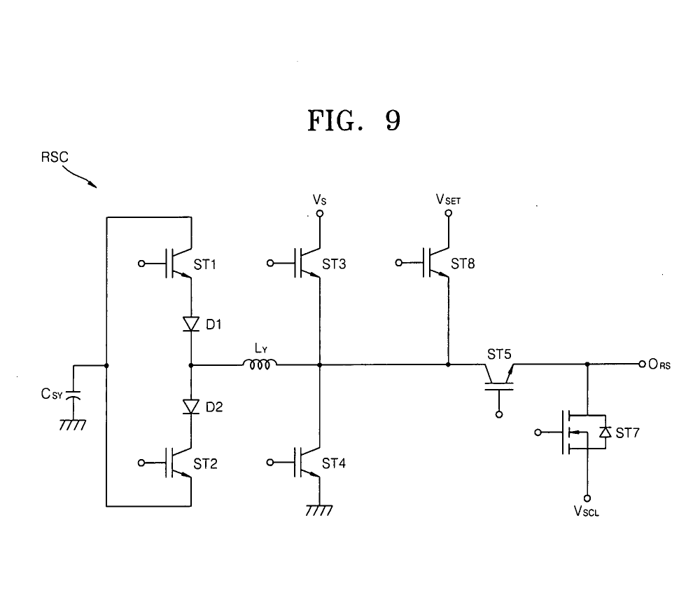

Referring to FIG. 5, during a potential rising period between time t3 and time t4 of the reset period R of the unit subfield SF, potential applied to the Y electrode lines Y₁, . . . , Yₙ may consistent rises from a third potential |V_{SCL}−V_{SCH}| with positive polarity to a first potential V_{SET}+|V_{SCL}−V_{SCH}| with positive polarity, e.g., 355 V. The first potential V_{SET}+|V_{SCL}−V_{SCH}| may be a higher than the third potential |V_{SCL}−V_{SCH}| by a sixth potential V_{SET}. The third potential |V_{SCL}−V_{SCH}| with positive polarity may be generated by a difference between a second potential V_{SCL} with negative polarity and a fourth potential V_{SCH} with negative polarity. Because the third potential |V_{SCL}−V_{SCH}| and the sixth potential V_{SET} may be combined by a capacitor, a rated voltage of a reset/sustain circuit (RSC) may be lower than the first potential V_{SET}+|V_{SCL}−V_{SCH}|, which will be described in detail later with reference to FIGS. 8 through 10.

A ground potential V_{G} may be applied to the X electrode lines X₁, . . . , Xₙ and the address electrode lines A_{R1}, . . . , A_{Bm}. Accordingly, a weak discharge may be generated between the Y electrode lines Y₁, . . . , Yₙ and the X electrode lines X₁, . . . , Xₙ, while a weaker discharge may be generated between the Y electrode lines Y₁, . . . , Yₙ and the address electrode lines A_{R1}, . . . , A_{Bm}.

A reason why the discharge between the Y electrode lines Y₁, . . . , Yₙ and the X electrode lines X₁, . . . , Xₙ may be stronger than the discharge between the Y electrode lines Y₁, . . . , Yₙ and the address electrode lines A_{R1}, . . . A_{Bm} may be because wall charges with negative polarities may be formed around the Y electrode lines Y₁, . . . , Yₙ and more wall charges with positive polarity may be formed around the X electrode lines X₁, . . . , Xₙ than the address electrode lines A_{R1}, . . . , A_{Bm}. That is, many wall charges with negative polarities may be formed around the Y electrode lines Y₁, . . . , Yₙ, wall charges with positive polarities may be formed around the X electrode lines X₁, . . . , Xₙ, and a fewer number of wall charges with positive polarities may be formed around the address electrode lines A_{R1}, . . . , A_{Bm} (see FIG. 6).

During a high-potential maintaining period between a t4 timing and a t5 timing of the reset period R, the potential applied to the Y electrode lines Y₁, . . . , Yₙ during the setting period may be maintained at the first potential V_{SET}+|V_{SCL}−V_{SCH}| with positive polarity.

More particularly, during the high-potential maintaining period between the time t4 and the time t5 after the potential rising period between the time t2 and time t4, the potential applied to the Y electrode lines Y₁, . . . , Yₙ may be maintained at the first potential V_{SET}+|V_{SCL}−V_{SCH}| with positive polarity. That is, e.g., after the potential rising period between time t3 and time t4, the potential of the Y electrode lines Y₁, . . . , Yₙ may not immediately drop to a fifth potential V_{S} with positive polarity, which may be lower than the first potential V_{SET}+|V_{SCL}−V_{SCH}| with positive polarity. In embodiments of the invention, the potential of the Y electrode lines Y₁, . . . , Yₙ may be maintained at the first potential V_{SET}+|V_{SCL}−V_{SCH}| with positive polarity before being allowed to substantially constantly and/or gradually fall from the first potential V_{SET}+|V_{SCL}−V_{SCH}| with positive polarity to, e.g., a voltage less than the fifth potential Vs, e.g., the ground voltage Vg.

Accordingly, the rated voltage of the driving apparatus may be lowered because two potentials can be combined using the capacitor. That is, the first potential may not affect the rated voltage of the reset/sustain circuit RSC, and the rated voltage of the RSC may be determined by whichever is higher between the third potential |V_{SCL}−V_{SCH}| and the sixth potential V_{SET}. Each of the third potential |V_{SCL}−V_{SCH}| and the sixth potential V_{SET} may be lower than the fifth potential V_{S}. The determination of the rated voltage of the RSC will be described in detail later with reference to FIGS. 8 through 10.

During a stabilizing period between a time t6 and a time t7 timing, the potential applied to the Y electrode lines Y₁, . . . , Yₙ may be maintained at the ground potential V_{G} while the potential applied to the X electrode lines X₁, . . . , Xₙ may be maintained at the fifth potential V_{S}. Accordingly, electromagnetic waves generated after the potential applied to the Y electrode lines Y₁, . . . , Yₙ falls from the first potential V_{SET}+|V_{SCL}−V_{SCH}| with positive polarity can be eliminated by the ground potential V_{G}.

During a potential falling period between the time t7 timing and a time t8 of the reset period R, the potential applied to the Y electrode lines Y₁, . . . , Yₙ may gradually fall from the ground potential V_{G} to the second potential V_{SCL} with negative polarity while the potential applied to the X electrode lines X₁, Xₙ may be maintained at the fifth potential V_{S}. Accordingly, some of the wall charges with negative polarity, which may be formed around the Y electrode lines Y₁, . . . , Yₙ may move to and stay around the X electrode lines X₁, . . . , Xₙ due to a discharge between the X electrode lines X₁, . . . , Xₙ and the Y electrode lines Y₁, . . . , Yₙ (see FIG. 7). In addition, because the ground potential V_{G} may be applied to the address electrode lines A_{R1}, . . . , A_{Bm}, the number of wall charges around the address electrode lines A_{R1}, . . . , A_{Bm} may increase slightly.

In the following addressing period A, a display data signal may be transmitted to the address electrode lines A_{R1}, . . . , A_{Bm} and scan pulses having the ground potential V_{G} may be sequentially transmitted to the Y electrode lines Y₁, . . . , Yₙ. The Y electrode lines Y₁, . . . , Yₙ may be biased by the fourth potential V_{SCH}, so that smooth addressing may be performed. As the display data signal is transmitted to each of the address electrode lines A_{R1}, . . . , A_{Bm}, an addressing potential V_{A} with positive polarity may be applied to selected display cells, while the ground potential V_{G} may be applied to the remaining display cells, i.e., non-selected display cells. Therefore, if the display data signal having the positive-polarity addressing potential V_{A} is transmitted while the scan pulses having the ground potential V_{G} are applied, wall charges may be formed by address discharge in the corresponding display cells. No wall charges may be formed in the remaining display cells to which, e.g., the display data signal having the ground potential V_{G} is applied. In embodiments of the invention, the fifth potential V_{S} may be applied to the X electrode lines X₁, . . . , Xₙ, to help improve the accuracy and efficiency of the address discharge process.

In the following sustain period S, sustain pulses of the fifth potential V_{S} with positive polarity may be alternately applied to all the Y electrode lines Y₁, . . . , Yₙ, and all the X electrode lines X₁, . . . , Xₙ, so that discharge for sustain may be generated in the display cells addressed in the previous addressing period A, i.e., display cell with the wall charges formed in the previous addressing period A.

FIG. 8 illustrates an exemplary scan driving circuit and an exemplary switching output circuit that may be employed in the Y driver 55 of the driving apparatus illustrated in FIG. 4. Referring to FIG. 8, the Y driver 55 may include a reset/sustain circuit RSC, a scan driving circuit AC, and a switching output circuit SIC. The reset/sustain circuit RSC may generate driving signals to be transmitted to the Y electrode lines Y₁, . . . , Yₙ during the reset period R and the sustain period S. The scan driving circuit AC may generate driving signals to be transmitted to the Y electrode lines Y₁, . . . , Yₙ during the addressing period A. In the switching output circuit SIC, upper transistors YU1, . . . , YUn and lower transistors YL1, . . . , YLn may be connected such that common output lines of the upper transistors YU1, . . . , YUn and the lower transistors YL1, . . . , YLn may respectively correspond to the Y electrode lines Y₁, . . . , Yₙ. Exemplary operation of the Y driver 55 will be described with reference to FIGS. 8 and 5.

During the addressing period A, a high-power transistor S_{SCL} of the scan driving circuit AC may be on. Accordingly, the second potential V_{SCL} with negative polarity, which may be a potential of a scan pulse, may be applied to the lower transistors YL1, . . . , YLn of the switching output circuit SIC through the high-power transistor S_{SCL} and a zener diode ZD. In addition, the fourth potential V_{SCH} with negative polarity, which may be a bias potential for scanning, may be applied to the upper transistors YU1, . . . , YUn of the switching output circuit SIC through a diode D_{M}. Therefore, during the addressing period A, a difference voltage |V_{SCL}−V_{SCH}| between the second potential V_{SCL} with negative polarity and the fourth potential V_{SCH} with negative polarity may be applied to a high-power capacitor C_{M}.

In this state, a lower transistor connected to a Y electrode line to be scanned may be turned on, and an upper transistor connected to the respective Y electrode may be turned off. Lower transistors connected to the remaining Y electrode lines may be turned off, and upper transistors connected to the remaining Y electrode lines may be turned on. Accordingly, the second potential V_{SCL} with negative polarity, which may be the potential of the scan pulse, may be applied to the Y electrode line to be scanned, and the fourth potential V_{SCH} with negative polarity, which may be the bias potential for scanning, may be applied to the remaining Y electrode lines.

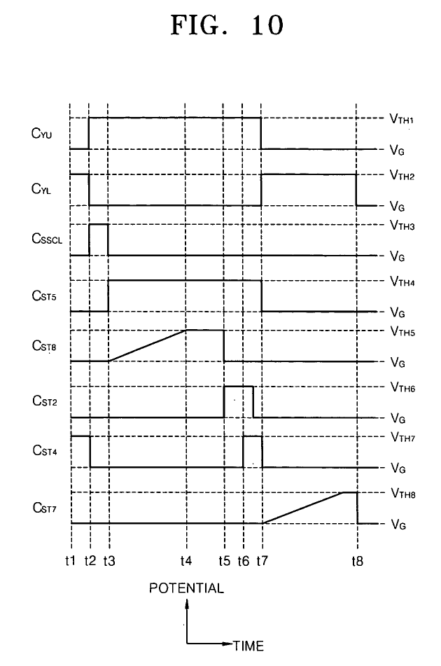

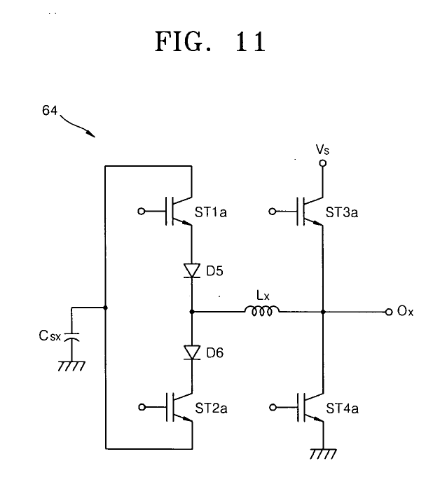

FIG. 9 illustrates an exemplary reset/sustain circuit illustrated in FIG. 8. Exemplary operation of the Y driver 55 during the reset period R and the sustain period S will be described with reference to the reset/sustain circuit RSC illustrated in FIG. 9. FIG. 10 illustrates exemplary control signals that may be supplied, during a reset period, to transistors illustrated in FIGS. 8 and 9. A method of transmitting an output signal O_{X} of an X driver 64 to the X electrode lines X₁, . . . , Xₙ will be described with reference to FIG. 10.

Referring to FIG. 10, a control signal C_{YU} may be transmitted to all of the upper transistors YU1, . . . , YUn of the switching output circuit SIC included in the Y driver 55 illustrated in FIG. 8. A control signal C_{YL} may be transmitted to all of the lower transistors YL1, . . . , YLn of the switching output circuit SIC included in the Y driver 55 illustrated in FIG. 8. A control signal C_{SSCL} may be transmitted to the high-power transistor S_{SCL} of the scan driving circuit AC included in the Y driver 55 illustrated in FIG. 8. A control signal C_{ST5} may be transmitted to a fifth transistor ST5 included in the reset/sustain circuit RSC of FIG. 9. A control signal C_{ST8} may be transmitted to an eighth transistor ST8 included in the reset/sustain circuit RSC illustrated in FIG. 9. A control signal C_{ST2} may be transmitted to a second transistor ST2 included in the reset/sustain circuit RSC illustrated in FIG. 9. A control signal C_{ST4} may be transmitted to a fourth transistor ST4 included in the reset/sustain circuit RSC illustrated in FIG. 9. A control signal C_{ST7} may be transmitted to a seventh transistor ST7 included in the reset/sustain circuit RSC illustrated in FIG. 9. Exemplary operation of the reset/sustain circuit RSC illustrated FIG. 9 will be described with reference to FIGS. 5, 8, 9, and 10.

During a first period between time t1 and time t2 of the reset period R of a unit subfield SF, the lower transistors YL1, . . . , YLn of the switching output circuit SIC included in the Y driver 55 may be on, and the fourth transistor ST4 of the reset/sustain circuit RSC may be on. Accordingly, the ground potential V_{G} may be applied to the Y electrode lines Y₁, . . . , Yₙ.

During a second period between time t2 and time t3 of the reset period R of the unit subfield SF, the high-power transistor S_{SCL} of the scan driving circuit AC and the upper transistors YU1, . . . , YUn of the switching output circuit SIC may be turned on. Accordingly, an initial potential of an upper electrode of the high-power capacitor C_{M} may rise to the third potential |V_{SCL}−V_{SCH}| with positive polarity, which may be the difference potential between the second potential V_{SCL} with negative polarity and the fourth potential V_{SCH} with negative polarity. In addition, as the lower transistors YL1, . . . , YLn of the switching output circuit SIC are turned off and the upper transistors YU1, . . . , YUn thereof are turned on, the third potential |V_{SCL}−V_{SCH}| with positive polarity may be applied to the Y electrode lines Y₁, . . . , Yₙ.

During a third period, e.g., the potential rising period, between the time t3 and the time t4, the upper transistors YU1, . . . , YUn of the switching output circuit SIC may be on, the high-power transistor S_{SCL} thereof may be turned off, and the fifth transistor ST5 of the reset/sustain circuit RSC may be turned on. In addition, as a control potential with positive polarity, which may be gradually rising, may be applied to a base of an eighth transistor ST8, the potential of the Y electrode lines Y₁, . . . , Yₙ may gradually rise from the third potential |V_{SCL}−V_{SCH}| with positive polarity to the first potential V_{SET}+|V_{SCL}−V_{SCH}| with positive polarity, e.g., 355 V. The first potential V_{SET}+|V_{SCL}−V_{SCH}| may be higher than the third potential |V_{SCL}−V_{SCH}| by the sixth potential V_{SET}.

Here, since the third potential |V_{SCL}−V_{SCH}| and the sixth potential V_{SET} may be combined using the capacitor, the rated voltage of the reset/sustain circuit RSC may be lower than the first potential V_{SET}+|V_{SCL}−V_{SCH}|

During a fourth period, e.g., the high-potential maintaining period, e.g., between the t4 timing and the t5 timing, the upper transistors YU1, . . . , YUn of the switching output circuit SIC and the fifth transistor ST5 of the reset/sustain circuit RSC may remain on, and a highest set potential with positive polarity may be applied to the base of the eighth transistor ST8. Accordingly, during the fourth period, e.g., the setting period, between the time t4 and the time t5, the potential applied to the Y electrode lines Y₁, . . . , Yₙ may be maintained at the first potential V_{SET}+|V_{SCL}−V_{SCH}| with positive polarity.

As described above, during the high-potential maintaining period, e.g., between the time t4 and the time t5, after the potential rising period, e.g., between the time t2 and the time t4, the potential may be maintained and may not fall to the fifth potential V_{S} with positive polarity. The fifth potential V_{S} may be lower than the first potential V_{SET}+|V_{SCL}−V_{SCH}| with positive polarity. Instead, as discussed above, the potential may be maintained, e.g., at the first potential V_{SET}+|V_{SCL}−V_{SCH}| with positive polarity. Accordingly, the rated voltage of the driving apparatus may be lowered because the plurality of potentials, e.g., two potentials, can be combined using the capacitor. That is, the first potential may not affect the rated voltage of the reset/sustain circuit RSC, and the rated voltage of the RSC may be determined by whichever is higher between, e.g., the third potential |V_{SCL}−V_{SCH}| and the sixth potential V_{SET}. Each of the third potential |V_{SCL}−V_{SCH}| and the sixth potential V_{SET} may be lower than the fifth potential V_{S}.

During a fifth period, e.g., between the time t5 and the time t6 of the reset period R, the upper transistors YU1, . . . , YUn of the switching output circuit SIC and the fifth transistor ST5 of the reset/sustain circuit RSC may remain on, and the second transistor ST2 of the reset/sustain circuit RSC may be turned on. Accordingly, unnecessary charges remaining in the display cells, i.e., electrical capacitors, may be collected by a capacitor C_{SY} for power reproduction through an output terminal O_{RS}, the fifth transistor ST5, a tuning coil L_{Y}, a second diode D2, and the second transistor ST2.

During a sixth period, e.g., the stabilization period, between the time t6 timing and the time t7, the upper transistors YU1, . . . , YUn of the switching output circuit SIC and the fifth transistor ST5 of the reset/sustain circuit RSC may remain on, and the fourth transistor ST4 of the reset/sustain circuit RSC may be turned on. Accordingly, the ground potential V_{G} may be applied to the Y electrode lines Y₁, . . . , Yₙ through the fourth transistor ST4 of the reset/sustain circuit RSC, the fifth transistor ST5, the output terminal O_{RS}, and the lower transistors YL1, . . . , YLn of the switching output circuit SIC. Therefore, electromagnetic waves generated after the potential applied to the Y electrode lines Y₁, . . . , Yₙ falls from the first potential V_{SET}+|V_{SCL}−V_{SCH}| with positive polarity may be eliminated by the ground potential V_{G}.

During a seventh period, e.g., the potential falling period, between the time t7 and the time t8 of the reset period R, a gradually rising potential with positive polarity may be applied to a gate of a seventh transistor ST7 while the upper transistors YU1, . . . , YUn of the switching output circuit SIC may be turned off, the lower transistors YL1, . . . , YLn of the switching output circuit SIC are turned on, and the fifth transistor ST5 of the reset/sustain circuit RSC may be turned off. Consequently, channel resistance of the seventh transistor ST7 may gradually decrease. Accordingly, the potential applied to the Y electrode lines Y₁, . . . , Yₙ may gradually fall from the ground potential V_{G} to the second potential V_{SCL} with negative polarity.

During the following addressing period A, all the transistors ST1 through ST8 of the reset/sustain circuit RSC may be turned off, and the output terminal O_{RS} of the reset/sustain circuit RSC may be put in an electrically floating state.

During the following sustain period S, the upper transistors YU1, YUn of the switching output circuit SIC may be turned off and the lower transistors YL1, . . . , YLn may be turned on. Exemplary operation of the reset/sustain circuit RSC is described below.

In a unit pulse applied to all the Y electrode lines Y₁, . . . , Yₙ, while, e.g., the potential applied to all the Y electrode lines Y₁, . . . , Yₙ falls from the fifth potential V_{S} with positive polarity to the ground potential V_{G}, only the second and fifth transistors ST2 and ST5 may be turned on. Accordingly, unnecessary charges remaining in the display cells, i.e., electrical capacitors, may be collected by the capacitor C_{SY} for power reproduction. The collected charges may be applied to all the Y electrode lines Y₁, . . . , Yₙ and may be reused. For example, such collected charges may be reused while the potential applied to the Y electrode lines Y₁, . . . , Yₙ is driven to rise from the ground potential V_{G} to the fifth potential V_{S} with positive polarity.

In a unit pulse applied to all the Y electrode lines Y₁, . . . , Yₙ during the sustain period S, while, e.g., the potential applied to the Y electrode lines Y₁, . . . , Yₙ rises from the ground potential V_{G} to the fifth potential V_{S} with positive polarity, the first and fifth transistors ST1 and ST5 may be turned on. Accordingly, the charges collected by the capacitor C_{SY} for power reproduction may be applied to all the Y electrode lines Y₁, . . . , Yₙ through a first field effect transistor ST1, a first diode D1, the tuning coil L_{Y}, a fifth field effect transistor ST5, and the output terminal O_{RS}.

Then, the third and fifth transistors ST3 and ST5 may be turned on. Thus, the fifth potential V_{S} with positive polarity may be applied to all the Y electrode lines Y₁, . . . , Yₙ. The third and fifth transistors ST3 and ST5 may be turned on when the sustain pulses stop rising.

When the potential applied to the Y electrode lines Y₁, . . . , Yₙ falls from the fifth potential V_{S} to the ground potential V_{G}, the second and fifth transistors ST2 and ST5 may be turned on. Accordingly, unnecessary charges remaining in the display cells, i.e., electrical capacitors, may be collected by the capacitor C_{SY} for power reproduction through the output terminal O_{RS}, the fifth transistor ST5, the tuning coil L_{Y}, the second diode D2, and the second transistor ST2.

Finally, the fourth and fifth transistors ST4 and ST5 may be turned on, and the ground potential V_{G} may be applied to all the Y electrode lines Y₁, Yₙ.

FIG. 11 illustrates an exemplary circuit diagram of the X driver included in the driving apparatus illustrated in FIG. 4. Exemplary operation of the X driver 64 using a driving method employing one or more aspects of the invention will be described with reference to FIGS. 11 and 5.

In the potential rising period between, e.g., the time t1 and the time t2 of the reset period R of the unit subfield SF, a fourth transistor ST4a may be turned on. Thus, an output signal O_{X} of the X driver 64 may become the ground potential V_{G}.

In the stabilizing period between, e.g., the time t2 the time t3, the potential falling period between the time t3 and the time t4, and the addressing period between the time t4 and the time t6, a third transistor ST3a may be turned on. Thus, the potential of the output signal O_{X} may become the fifth potential V_{S}.

In a unit pulse applied to all the X electrode lines X₁, . . . , Xₙ during, e.g., the following sustain period S, a second transistor ST2a may be turned on while the potential applied to the X electrode lines X₁, . . . , Xₙ may fall from the fifth potential V_{S} to the ground potential V_{G}. Accordingly, unnecessary charges remaining in the display cells, i.e., electrical capacitors, may be collected by a capacitor C_{SX} for power reproduction. The collected charges are applied to all the X electrode lines X₁, . . . , Xₙ and thus reused while the potential applied to all the X electrode lines X₁, . . . , Xₙ rises from the ground potential V_{G} to the fifth potential V_{S} with positive polarity.

In the unit pulse applied to all the X electrode lines X₁, . . . , Xₙ during the sustain period S, while the potential applied to the X electrode lines X₁, . . . , Xₙ, rises from the ground potential V_{G} to the fifth potential V_{S} with positive polarity, the first transistor ST1a is turned on. Accordingly, the charges collected by the capacitor C_{SX} for power reproduction may be applied to all the X electrode lines X₁, . . . , Xₙ through the first transistor ST1a, a fifth diode D5, a tuning coil L_{X}, and the output terminal O_{X}

Then, a third transistor ST3a is turned on, and the fifth potential V_{S} with positive polarity may be applied to all the X electrode lines X₁, . . . , Xₙ. The third transistor ST3a is turned on when the sustain pulses stop rising.

When the potential applied to the X electrode lines X₁, . . . , Xₙ falls from the fifth potential V_{S} to the ground potential V_{G}, the second transistor ST2a is turned on. Accordingly, unnecessary charges remaining in the display cells, i.e., electrical capacitors, may be collected by the capacitor C_{SX} for power reproduction through the tuning coil L_{X}, a sixth diode D6, and the second transistor ST2a.

Finally, the fourth transistor ST4a may be turned on, and the ground potential V_{G} may be applied to all the X electrode lines X₁, . . . , Xₙ.

As described above, according to a method of driving a discharge display panel, after a potential rising period, the highest potential may be maintained during a high-potential maintaining period before falling to a lower potential. Accordingly, a rated voltage of a driving apparatus employing such a driving method may be lowered because two potentials may be combined using a charge storage device, e.g., a capacitor. Thus, the highest potential does not affect the rated voltage of the driving apparatus.

Although exemplary embodiments of the driving method may be described in relation to an exemplary plasma display device, embodiments of the invention are not limited to use with a plasma display device. Plasma display devices are merely one type of device that may employ a driving method employing one or more aspects of the invention. For example, driving methods employing one or more aspects of the invention may be employed by various discharge display devices including, e.g., a three electrode structure.

Exemplary embodiments of the invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the invention as set forth in the following claims.

What is claimed is:

1. A method of driving a discharge display panel, including X electrode lines, Y electrode lines and address electrode lines, to display at least one frame of an image, wherein the frame includes a plurality of subfields, and during a reset period of at least one of the plurality of subfields, the method comprises:
increasing a potential of the Y electrode lines to a first potential with positive polarity;
maintaining the Y electrode lines at the first potential for a setting time;
gradually dropping the potential of the Y electrode lines from the first potential to a ground potential;
maintaining the Y electrode lines at the ground potential for a predetermined period of time; and
dropping the potential of the Y electrode lines from the ground potential to a second potential with negative polarity.

2. The method as claimed in claim 1, wherein increasing the potential of the Y electrode lines to the first potential comprises gradually increasing the potential of the Y electrode lines from a third potential with positive polarity to the first potential with positive polarity.

3. The method as claimed in claim 2, wherein increasing the potential of the Y electrode lines to the first potential further comprises substantially instantaneously increasing the potential of the Y electrode lines from the ground potential to the third potential and maintaining the Y electrodes lines at the third potential for a predetermined period of time.

4. The method as claimed in claim 3, wherein increasing the potential of the Y electrode lines to the first potential comprises gradually increasing the potential of the Y electrode lines from the third potential to the first potential.

5. The method as claimed in claim 2, further comprising applying the ground potential to the X electrode lines while increasing the potential of the Y electrode lines from the third potential with positive polarity to the first potential with positive polarity, and while maintaining the Y electrode lines at the first potential during the setting time.

6. The method as claimed in claim 5, further comprising applying a fifth potential with positive polarity lower than the first potential with positive polarity to the X electrode lines while dropping the potential of the Y electrode lines from the first potential to the second potential.

7. The method as claimed in claim 1, wherein the address electrode lines are maintained at the ground potential during the reset period.

8. The method as claimed in claim 1, further comprising applying a pulse of the second potential with negative polarity to respective ones of the Y electrode lines to be selected, and applying a fourth potential with negative polarity higher than that second potential with negative polarity to unselected ones of the Y electrode lines.

9. The method as claimed in claim 1, wherein the discharge display panel is a plasma display panel.

10. A method of driving a discharge display panel including X electrode lines, Y electrode lines, and address electrode lines by using a driving apparatus of a discharge display apparatus, the method comprising:
dividing a unit frame into a plurality of subfields for a time-sharing gray-scale display; and
dividing each of the subfields into a reset period, an addressing period, and a sustain period,
wherein the reset period of at least one of the subfields includes:
a potential rising period during which a potential applied to the Y electrode lines gradually rises to a first potential with positive polarity;
a high-potential maintaining period during which the potential applied to the Y electrode lines is maintained at the first potential with positive polarity for a setting time;
a stabilizing period during which the potential applied to the Y electrode lines is maintained at a ground potential; and
a potential falling period during which the potential applied to the Y electrode lines gradually falls from the ground potential to a second potential with negative polarity.

11. The method as claimed in claim 10, wherein the driving apparatus comprises:
an X driver driving the X electrode lines;
an Y driver driving the Y electrode lines; and
an address driver driving the address electrode lines,
wherein the Y driver includes:
a reset/sustain circuit generating potentials to be applied to the Y electrode lines during the reset and sustain periods;
a scan driving circuit generating potentials to be applied to the Y electrode lines during the addressing period; and
a switching output circuit applying the potentials from the reset/sustain circuit and the potentials from the scan driving circuit to the Y electrode lines,
wherein the switching output circuit includes upper transistors and lower transistors respectively corresponding to the Y electrode lines, the method including applying potentials to the Y electrode lines through the upper transistors of the switching output circuit during the potential rising period, the high-potential maintaining period, and the stabilizing period.

12. The method as claimed in claim 11, wherein, during the potential falling period, the method further comprises applying the potentials to the Y electrode lines through the lower transistors of the switching output circuit.

13. The method as claimed in claim 12, wherein the potential applied to the Y electrode lines gradually rises from a third potential with positive polarity to the first potential with positive polarity.

14. The method as claimed in claim 13, wherein, during the addressing period, a pulse of the second potential with negative polarity is applied to some of the Y electrode lines to be scanned, and a fourth potential with negative polarity higher than the second potential with negative polarity is applied to the remaining Y electrode lines.

15. The method as claimed in claim 14, wherein the third potential with positive polarity is generated by a difference between the second potential with negative polarity and the fourth potential with negative polarity during the potential rising period.

16. The method as claimed in claim 15, wherein the ground potential is applied to the X electrode lines during the potential rising period.

17. The method as claimed in claim 16, wherein a fifth potential with positive polarity lower than the first potential with positive polarity is applied to the X electrode lines.

18. The method as claimed in claim 10, wherein the discharge display panel is a plasma display panel.

19. A driving apparatus for driving a discharge panel including X electrode lines, Y electrode lines and address electrode lines, the driving apparatus including:
a processor for dividing a unit frame into a plurality of subfields for a time-sharing gray scale display, and dividing each of the subfields into a reset period, an addressing period, and a sustain period; and
a Y driver for driving the Y electrode lines, the Y driver including:
a reset/sustain circuit for generating potentials to be applied to the Y electrodes lines during the reset and sustain periods, the reset/sustain circuit including:
potential increasing means for increasing a potential of the Y electrode lines to a first potential with positive polarity;
high-potential maintaining means for maintaining the potential of the Y electrode lines at the first potential for a setting time;
stabilizing means for stabilizing the Y electrode lines by applying a ground potential to the Y electrode lines; and
potential dropping means for allowing the potential applied to the Y electrode lines to gradually fall from the ground potential to a second potential with negative polarity.

20. The driving apparatus as claimed in claim 19, further comprising:
a scan driving circuit for generating potentials to be applied to the Y electrode lines during the addressing period; and
a switching output circuit for applying the potentials from the reset/sustain circuit with potentials from the scan driving circuit to the Y electrode lines,
wherein:
the switching output circuit includes upper transistors and lower transistors respectively corresponding to the Y electrode lines, and
the potential increasing means, the high-potential maintaining means and the stabilizing means use the upper transistors of the switching circuit to control the potentials applied to the Y electrode lines.
